(19) United States
(12) Patent Application Publication
(10) Pub. No.: US 2022/0338545 A1
(43) Pub. Date: Oct. 27, 2022

(54) AEROSOL-GENERATING DEVICE WITH AXIALLY MOVABLE INDUCTION HEATER

(71) Applicant: Philip Morris Products S.A., Neuchatel (CH)

(72) Inventors: Rui Nuno BATISTA, Morges (CH); Ricardo CALI, Mannheim (DE)

(73) Assignee: Philip Morris Products S.A., Neuchatel (CH)

(21) Appl. No.: 17/635,516

(22) PCT Filed: Aug. 25, 2020
(86) PCT No.: PCT/EP2020/073699

§ 371 Date: Feb. 15, 2022

(30) Foreign Application Priority Data
Aug. 28, 2019 (EP) 19194032.9

(51) Int. Cl. A24F 40/465; A24F 40/20; H05B 6/10; H05B 6/36

(52) U.S. Cl. CPC A24F 40/465; A24F 40/20; H05B 6/105; H05B 6/36

(57) ABSTRACT

An aerosol-generating device is provided, including: a cavity to receive an aerosol-generating article including an aerosol-forming substrate; and an induction heating arrangement including a susceptor arrangement and an induction coil, the induction coil being arranged at least partly surrounding the susceptor arrangement, and the induction coil being arranged axially movable along the susceptor arrangement, and a guiding element to guide the axial movement of the induction coil, the induction coil being movable to at least a first heating position and a second heating position around the cavity, the susceptor arrangement including at least a first susceptor and a second susceptor, which are arranged distanced from each other along a longitudinal axis of the aerosol-generating device, and the induction coil being movable to surround the first susceptor corresponding to the first heating position and movable to surround the second susceptor corresponding to the second heating position.

The present invention relates to an aerosol-generating device.

It is known to provide an aerosol-generating device for generating an inhalable vapor. Such devices may heat aerosol-forming substrate to a temperature at which one or more components of the aerosol-forming substrate are volatilised without burning the aerosol-forming substrate. An aerosol-forming substrate may be provided as part of an aerosol-generating article. The aerosol-generating article may have a rod shape for insertion of the aerosol-generating article into a cavity, such as a heating chamber, of the aerosol-generating device. A heating arrangement may be arranged around the heating chamber for heating the aerosol-forming substrate once the aerosol-generating article is inserted into the heating chamber of the aerosol-generating device. The heating arrangement may be an induction heating arrangement. The induction heating arrangement may comprise a susceptor arrangement and an induction coil. The heating arrangement may be arranged around the cavity. Heat generation of the heating arrangement may uniformly heat the aerosol-generating article received in the cavity. Uniform heating of the aerosol-generating article with a temperature high enough to create a satisfying aerosol may result in fast depletion of the aerosol-forming substrate of the aerosol-forming article.

It would be desirable to have an aerosol-generating device, in which too fast depletion of an aerosol-forming substrate of an aerosol-generating article received in a cavity of the aerosol-generating device is prevented. It would be desirable to have an aerosol-generating device, in which sectional heating of an aerosol forming substrate of an aerosol-forming article is enabled.

According to an embodiment of the invention, there is provided an aerosol-generating device comprising a cavity for receiving an aerosol-generating article comprising aerosol-forming substrate. The device further comprises an induction heating arrangement. The induction heating arrangement comprises a susceptor arrangement and an induction coil. The induction coil is arranged at least partly surrounding the susceptor arrangement. The induction coil is arranged axially movable along the susceptor arrangement. The induction heating arrangement comprises a guiding element configured to guide the axial movement of the induction coil.

The movable induction coil facilitates that portions of the susceptor arrangement may be heated. Heating portions of the susceptor arrangement leads to heating of different portions of a substrate portion of the aerosol-generating article, when the aerosol-generating article is received in the cavity. The heated area within the cavity associated with a position of the induction coil may be referred to as heating zone. Multiple heating zones may be provided by configuring the induction coil movable. The heating zones may be arranged along the longitudinal axis of the cavity. The heating zones may be different from each other. The position of the heating zones may be different from each other. The heating zones may be arranged adjacent each other. Two heating zones may be provided. More than two heating zones may be provided. The induction coil may be movable between two positions. The induction coil may be movable between more than two positions. The induction coil may be movable to the first position. The first position of the induction coil may correspond to a first heating zone. The induction coil may be movable to the second position. The second position may be different from the first position. The second position of the induction coil may correspond to a second heating zone. The first heating zone may be in a downstream region of the cavity. The second heating zone may be in an upstream region of the cavity. The guiding element may be attached to the induction coil or vice versa. The induction coil may be securely held within the guiding element or adjacent to the guiding element. The induction coil may be mounted on the guiding element. The guiding element may comprise a U-shaped recess for receiving the induction coil. The U-shaped recess may face towards the cavity. The guiding element may partly surround the induction coil.

The term “axially” may refer to a direction parallel or along the longitudinal axis of the aerosol-generating device. The induction coil being axially movable may mean that only the induction coil, preferably together with the guiding element, may be axially movable. The susceptor may be stationary.

The aerosol-generating device may further comprise a housing. The housing may comprise a guiding slot. The guiding element may be configured engageable or engaged with the guiding slot. The induction heating arrangement may be arranged inside of the housing. The housing may comprise an inner housing and an outer housing. The guiding slot may be provided in the inner housing. The guiding slot may be configured as a female guiding slot and the guiding element may be configured as a male guiding element or vice versa. The guiding element may be configured to engage with the guiding slot. The guiding element may be security held within the guiding slot. The guiding element may have an H-shaped cross-section. The guiding element may extend through the guiding slot. An outer part of the guiding element may be arranged radially outside of the guiding slot. An inner part of the guiding element may be arranged radially inside of the guiding slot. A bridging part of the guiding element may connect the inner part of the guiding element with the outer part of the guiding element. Radial movement of the guiding element may be prevented by the engagement between the guiding element and the guiding slot. By means of movement of the guiding element, the induction coil may be moved.

The guiding slot may be configured as a helical guiding slot. Movement of the guiding element within the guiding slot may be enabled. Movement of the guiding element may be enabled according to the shape of the guiding slot. A helical movement of the guiding element may be enabled by the helical guiding slot. A tangential movement of the guiding element in combination with an axial movement of the guiding element may be enabled by the helical guiding slot. As a consequence, a tangential movement of the induction coil in combination with an axial movement of the induction coil may be enabled by the helical guiding slot.

The guiding element and the guiding slot may be configured to enable a rotational movement of the induction coil around a longitudinal axis of the aerosol-generating device thereby leading to the axial movement of the induction coil. Movement of the guiding element within the guiding slot may lead to movement of the induction coil. This movement may lead to an axial movement of the induction coil. The movement of the guiding element may facilitate movement of the induction coil between different positions such as the first position corresponding to the first heating zone and the second position corresponding to the second heating zone.

The susceptor arrangement may be arranged along the full length of the cavity. The induction coil may partly surround the susceptor arrangement. The susceptor arrangement may be arranged along a part of the cavity in which the substrate portion of the aerosol-generating article is received, when the aerosol-generating article is received in the cavity. The susceptor arrangement may surround the circumference of the cavity. The susceptor arrangement may fully surround the circumference of the cavity. The susceptor arrangement may fully surround the whole cavity. The induction coil may fully surround the susceptor arrangement. The induction coil may partly surround the susceptor arrangement. Particularly, if the induction coil is configured movable, it is desired that the induction coil is partly surrounding the susceptor arrangement. The movement of the induction coil may lead to the induction coil surrounding different parts of the susceptor arrangement. Exemplarily, the induction coil may be moved to the first position corresponding to the first heating zone, in which case the induction coil may surround a first portion of the susceptor arrangement. The induction coil may be moved to the second position corresponding to the second heating zone, in which case the induction coil may surround a second portion of the susceptor arrangement. The first position of the induction coil may be referred to as first heating position and the second position of the induction coil may be referred to a second heating position.

The aerosol-generating device may further comprise a motor for moving the induction coil. The aerosol-generating device may be configured to automatically move the induction coil between the first heating position and the second heating position. The motor may be an electric motor. The motor may be a linear motor. The induction coil may be automatically moved, if the aerosol-forming substrate of the aerosol-generating article heated by the induction coil is depleted. Exemplarily, the induction coil may be initially placed in the first heating position. After depletion of the aerosol-forming substrate contained in the first heating zone corresponding to the first heating position, the induction coil may be automatically moved. The induction coil may be automatically moved to the second heating position to heat fresh aerosol-forming substrate contained in the second heating zone corresponding to the second heating position.

Control of the motor may be facilitated by a controller as described herein. The controller may be configured to control the operation of the motor depending upon an operation time of the induction coil. If the induction coil is placed in a specific position such as the first heating position and operated for a time exceeding a predetermined threshold, the controller may control the motor to move the induction coil towards a further position such as the second heating position.

The susceptor arrangement may comprise at least a first susceptor and a second susceptor, which are arranged distanced from each other along a longitudinal axis of the aerosol-generating device. The induction coil may be configured movable to surround the first susceptor corresponding to the first heating position and configured movable to surround the second susceptor corresponding to the second heating position.

The first susceptor may be arranged surrounding the first heating zone. The second susceptor may be arranged surrounding the second heating zone. The first susceptor may be arranged distanced from the second susceptor. The first susceptor may fully surround the circumference of the cavity. The second susceptor may fully surround the circumference of the cavity. The longitudinal axis of the aerosol-generating device may be identical to the longitudinal axis of the cavity.

An electrically insulating element may be arranged between the first susceptor and the second susceptor. The electrically insulating element may electrically insulate the first susceptor from the second susceptor. The electrically insulating element may be ring-shaped. The electrically insulating element may have a diameter corresponding to the diameter of the first and second susceptors. The electrically insulating element may be tubular.

The susceptor arrangement may comprise at least two elongate susceptors arranged parallel to a longitudinal axis of the aerosol-generating device. The susceptors may be blade shaped. The susceptors may be arranged within the cavity in a tubular arrangement so that the aerosol-generating article can be held between the susceptors.

Gaps may be provided between the susceptors. The gaps may allow air to be drawn into the aerosol-generating article in a radial direction.

The susceptors may be arranged around a sidewall of the cavity in a tubular arrangement.

The invention further relates to an aerosol-generating device comprising a cavity for receiving an aerosol-generating article comprising aerosol-forming substrate. The device further comprises an induction heating arrangement. The induction heating arrangement comprises a susceptor arrangement and at least a first induction coil and a second induction coil. The susceptor arrangement is arranged at least partly surrounding the cavity. The first induction coil is arranged surrounding a first region of the susceptor arrangement. The second induction coil is arranged surrounding a second region of the susceptor arrangement.

The aerosol-generating device may comprise a power supply. The power supply may be a direct current (DC) power supply. The power supply may be electrically connected to the first induction coil. In one embodiment, the power supply is a DC power supply having a DC supply voltage in the range of about 2.5 Volts to about 4.5 Volts and a DC supply current in the range of about 1 Amp to about 10 Amps (corresponding to a DC power supply in the range of about 2.5 Watts to about 45 Watts). The aerosol-generating device may advantageously comprise a direct current to alternating current (DC/AC) inverter for converting a DC current supplied by the DC power supply to an alternating current. The DC/AC converter may comprise a Class-D or Class-E power amplifier. The power supply may be configured to provide the alternating current. The power supply may be configured to power the motor for moving the induction coil.

The power supply may be a battery, such as a rechargeable lithium ion battery. Alternatively, the power supply may be another form of charge storage device such as a capacitor. The power supply may require recharging. The power supply may have a capacity that allows for the storage of enough energy for one or more uses of the aerosol-generating device. For example, the power supply may have sufficient capacity to allow for the continuous generation of aerosol for a period of around six minutes, corresponding to the typical time taken to smoke a conventional cigarette, or for a period that is a multiple of six minutes. In another example, the power supply may have sufficient capacity to allow for a predetermined number of puffs or discrete activations.

The power supply may be configured to operate at high frequency. As used herein, the term “high frequency oscillating current” means an oscillating current having a frequency of between 500 kilohertz and 30 megahertz. The high frequency oscillating current may have a frequency of from about 1 megahertz to about 30 megahertz, preferably from about 1 megahertz to about 10 megahertz and more preferably from about 5 megahertz to about 8 megahertz.

The induction heating arrangement may be configured to generate heat by means of induction. The induction heating arrangement comprises an induction coil and a susceptor arrangement. A single induction coil may be provided. A single susceptor arrangement may be provided. Preferably, more than a single induction coil is provided. A first induction coil and a second induction coil may be provided. Preferably, more than a single susceptor arrangement is provided. Preferably, a first susceptor arrangement and a second susceptor arrangement are provided or the susceptor arrangement comprises a first susceptor and a second susceptor. The induction coil may surround the susceptor arrangement. The first induction coil may surround the first susceptor arrangement or the first susceptor. The second induction coil may surround the second susceptor arrangement or the second susceptor. Alternatively, at least two induction coils may be provided surrounding a single susceptor arrangement. If more than one susceptor arrangement are provided, preferably electrically insulating elements as described herein are provided between the susceptor arrangements.

The susceptor arrangement may comprise a susceptor. The susceptor arrangement may comprise multiple susceptors. The susceptor arrangement may comprise blade shaped susceptors. Alternatively, the susceptor arrangement may comprise tubular susceptors. The blade shaped susceptors may be arranged surrounding the cavity. The blade shaped susceptors may be arranged inside of the cavity. The blade shaped susceptors may be arranged for holding the aerosol-generating article, when the aerosol-generating article is inserted into the cavity. The blade shaped susceptors may have flared downstream ends to facilitate insertion of the aerosol-generating article into the blade shaped susceptors. If the susceptors are provided with a tubular shape, a similar arrangement of the susceptors may be utilized. The tubular susceptors may be arranged surrounding the cavity. The tubular susceptors may be arranged within the cavity.

Air may flow into the cavity through an air aperture in the base of the cavity. The air may subsequently enter into the aerosol-generating article at the upstream end face of the aerosol-generating article. Alternatively or additionally, air may flow between the sidewall of the cavity, preferably formed by a thermally insulating element, and the blade shaped susceptors. The air may then enter into the aerosol-generating article through gaps between the blade shaped susceptors. A uniform penetration of the aerosol-generating article with air may be achieved in this way, thereby optimizing aerosol generation. If the susceptors are tubular, the tubular susceptors may have an inner diameter corresponding to or slightly smaller to the outer diameter of the aerosol-generating article. The aerosol-generating article may be held by the tubular susceptors. In this case, air may predominantly or only enter the aerosol-generating article at the upstream end face of the aerosol-generating article. Alternatively, the tubular susceptors may have an inner diameter larger than the outer diameter of the aerosol-generating article. In this case, air may enter into the aerosol-generating article at the upstream end face of the aerosol-generating article. Additionally, air may enter radially into the aerosol-generating article from the outer circumference of the aerosol-generating article.

The aerosol-generating device may comprise a flux concentrator. The flux concentrator may be made from a material having a high magnetic permeability. The flux concentrator may be arranged surrounding the induction heating arrangement. The flux concentrator may concentrate the magnetic field lines to the interior of the flux concentrator thereby increasing the heating effect of the susceptor arrangement by means of the induction coil. If multiple susceptor elements are provided, the flux concentrator may additionally or alternatively be arranged between the susceptor elements. The flux concentrator may be configured to concentrate the magnetic field lines towards the susceptor element which is surrounded by the induction coil. Exemplarily, if the induction coil is positioned in the first heating position surrounding the first susceptor element, the flux concentrator may be configured to concentrate the magnetic field lines in the first susceptor. If the induction coil is subsequently moved to the second heating position surrounding the second susceptor, the flux concentrator may be configured to concentrate the magnetic field lines in the second susceptor. Preferably, the flux concentrator is stationary. The flux concentrator may be attached to the housing, preferably the housing, of the aerosol-generating device. Alternatively, the flux concentrator may be movable. The flux concentrator may be attached to one or both of the induction coil and the guiding element. The flux concentrator may be configured to move together with the induction coil.

The aerosol-generating device may comprise a controller. The controller may be electrically connected to the induction coil. The controller may be electrically connected to the first induction coil and to the second induction coil. The controller may be configured to control the electrical current supplied to the induction coils, and thus the magnetic field strength generated by the induction coils. The controller may be connected to the motor configured to move the induction coil. The controller may be configured to control operation of the motor. The controller may be configured to control the supply of electrical energy from the power supply to the motor.

The power supply and the controller may be connected to the induction coil, preferably the first and second induction coils and configured to provide the alternating electric current to each of the induction coils independently of each other such that, in use, the induction coils each generate the alternating magnetic field. This means that the power supply and the controller may be able to provide the alternating electric current to the first induction coil on its own, to the second induction coil on its own, or to both induction coils simultaneously. Different heating profiles may be achieved in that way. The heating profile may refer to the temperature of the respective induction coil. To heat to a high temperature, alternating electric current may be supplied to both induction coils at the same time. To heat to a lower temperature or to heat only a portion of the aerosol-forming substrate of the aerosol-generating article, alternating electric current may be supplied to the first induction coil only. Subsequently, alternating electric current may be supplied to the second induction coil only.

The controller may be connected to the induction coils and the power supply. The controller may be configured to control the supply of power to the induction coils from the power supply. The controller may comprise a microprocessor, which may be a programmable microprocessor, a microcontroller, or an application specific integrated chip (ASIC) or other electronic circuitry capable of providing control. The controller may comprise further electronic components. The controller may be configured to regulate a supply of current to the induction coils. Current may be supplied to one or both of the induction coils continuously following activation of the aerosol-generating device or may be supplied intermittently, such as on a puff by puff basis.

The power supply and the controller may be configured to vary independently the amplitude of the alternating electric current supplied to each of the first induction coil and the second induction coil. With this arrangement, the strength of the magnetic fields generated by the first and second induction coils may be varied independently by varying the amplitude of the current supplied to each coil. This may facilitate a conveniently variable heating effect. For example, the amplitude of the current provided to one or both of the coils may be increased during start-up to reduce the initiation time of the aerosol-generating device.

The first induction coil of the aerosol-generating device may form part of a first circuit. The first circuit may be a resonant circuit. The first circuit may have a first resonant frequency. The first circuit may comprise a first capacitor. The second induction coil may form part of a second circuit. The second circuit may be a resonant circuit. The second circuit may have a second resonant frequency. The first resonance frequency may be different from the second resonance frequency. The first resonance frequency may be identical to the second resonance frequency. The second circuit may comprise a second capacitor. The resonant frequency of the resonant circuit depends on the inductance of the respective induction coil and the capacitance of the respective capacitor.

The cavity of the aerosol-generating device may have an open end into which an aerosol-generating article is inserted. The cavity may have a closed end opposite the open end. The closed end may be the base of the cavity. The closed end may be closed except for the provision of the air apertures arranged in the base. The base of the cavity may be flat. The base of the cavity may be circular. The base of the cavity may be arranged upstream of the cavity. The open end may be arranged downstream of the cavity. The longitudinal direction may be the direction extending between the open and closed ends. The longitudinal axis of the cavity may be parallel with the longitudinal axis of the aerosol-generating device.

The cavity may be configured as a heating chamber. The cavity may have a cylindrical shape. The cavity may have a hollow cylindrical shape. The cavity may have a circular cross-section. The cavity may have an elliptical or rectangular cross-section. The cavity may have a diameter corresponding to the diameter of the aerosol-generating article.

As used herein, the term “proximal” refers to a user end, or mouth end of the aerosol-generating device, and the term “distal” refers to the end opposite to the proximal end. When referring to the cavity, the term “proximal” refers to the region closest to the open end of the cavity and the term “distal” refers to the region closest to the closed end.

As used herein, the term “length” refers to the major dimension in a longitudinal direction of the aerosol-generating device, of an aerosol-generating article, or of a component of the aerosol-generating device or an aerosol-generating article.

As used herein, the term “width” refers to the major dimension in a transverse direction of the aerosol-generating device, of an aerosol-generating article, or of a component of the aerosol-generating device or an aerosol-generating article, at a particular location along its length. The term “thickness” refers to the dimension in a transverse direction perpendicular to the width.

As used herein, the term “aerosol-forming substrate” relates to a substrate capable of releasing volatile compounds that can form an aerosol. Such volatile compounds may be released by heating the aerosol-forming substrate. An aerosol-forming substrate is part of an aerosol-generating article.

As used herein, the term “aerosol-generating article” refers to an article comprising an aerosol-forming substrate that is capable of releasing volatile compounds that can form an aerosol. For example, an aerosol-generating article may be an article that generates an aerosol that is directly inhalable by the user drawing or puffing on a mouthpiece at a proximal or user-end of the system. An aerosol-generating article may be disposable. An article comprising an aerosol-forming substrate comprising tobacco is referred to as a tobacco stick. The aerosol-generating article may be insertable into the cavity of the aerosol-generating device.

As used herein, the term “aerosol-generating device” refers to a device that interacts with an aerosol-generating article to generate an aerosol.

As used herein, the term “aerosol-generating system” refers to the combination of an aerosol-generating article, as further described and illustrated herein, with an aerosol-generating device, as further described and illustrated herein. In the system, the aerosol-generating article and the aerosol-generating device cooperate to generate a respirable aerosol.

As used herein, a “susceptor arrangement” means a conductive element that heats up when subjected to a changing magnetic field. This may be the result of eddy currents induced in the susceptor arrangement, hysteresis losses, or both eddy currents and hysteresis losses. During use, the susceptor arrangement is located in thermal contact or close thermal proximity with the aerosol-forming substrate of an aerosol-generating article received in the cavity of the aerosol-generating device. In this manner, the aerosol-forming substrate is heated by the susceptor arrangement such that an aerosol is formed.

The susceptor arrangement may have a cylindrical shape, preferably constituted by individual blade shaped susceptors. The susceptor arrangement may have a shape corresponding to the shape of the corresponding induction coil. The susceptor arrangement may have a diameter smaller than the diameter of the corresponding induction coil such that the susceptor arrangement can be arranged inside of the induction coil. As an alternative to the blade shape susceptors, the susceptors may be tubular. The susceptors may have a cylindrical shape. The susceptors may have a hollow cylindrical shape.

The term “heating zone” refers to a portion of the length of the cavity which is at least partially surrounded by the induction coils so that the susceptor arrangement placed in or around the heating zone is inductively heatable by the induction coils. The heating zone may comprise a first heating zone and a second heating zone. The heating zone may be split into the first heating zone and the second heating zone. The first heating zone may be surrounded by the first induction coil. The second heating zone may be surrounded by the second induction coil. More than two heating zones may be provided. Multiple heating zones may be provided. An induction coil may be provided for each heating zone. One or more induction coils may be arranged moveable to surround the heating zones and configured for segmented heating of the heating zones. As a preferred embodiment, the a single induction coil is provided, which is movable between the different heating zones to surround the respective heating zones.

The term “coil” as used herein is interchangeable with the terms “inductive coil” or “induction coil” or “inductor” or “inductor coil” throughout. A coil may be a driven (primary) coil connected to the power supply.

The heating effect may be varied by controlling the first and second induction coils independently. The heating effect may be varied by providing the first and second induction coils with different configurations so that the magnetic field generated by each coil under the same applied current is different. For example, the heating effect may be varied by forming the first and second induction coils from different types of wire so that the magnetic field generated by each coil under the same applied current is different. The heating effect may be varied by controlling the first and second induction coils independently and by providing the first and second induction coils with different configurations so that the magnetic field generated by each coil under the same applied current is different.

The induction coil(s) are each disposed at least partially around the heating zone. The induction coil may extend only partially around the circumference of the cavity in the region of the heating zone. The induction coil may extend around the entire circumference of the cavity in the region of the heating zone.

The induction coil(s) may be a planar coil disposed around part of the circumference of the cavity or fully around the circumference of the cavity. As used herein a “planar coil” means a spirally wound coil having an axis of winding which is normal to the surface in which the coil lies. The planar coil may lie in a flat Euclidean plane. The planar coil may lie on a curved plane. For example, the planar coil may be wound in a flat Euclidian plane and subsequently bent to lie on a curved plane.

Advantageously, the induction coil(s) is helical. The induction coil may be helical and wound around a central void in which the cavity is positioned. The induction coil may be disposed around the entire circumference of the cavity.

The induction coil(s) may be helical and concentric. The first and second induction coils may have different diameters. The first and second induction coils may be helical and concentric and may have different diameters. In such embodiments, the smaller of the two coils may be positioned at least partially within the larger of the first and second induction coils.

The windings of the first induction coil may be electrically insulated from the windings of the second induction coil.

The aerosol-generating device may further comprise one or more additional induction coils. For example, the aerosol-generating device may further comprise third and fourth induction coils, preferably associated with additional susceptors, preferably associated with different heating zones. If multiple susceptors are provided, respective multiple electrically insulating elements may be provided between the susceptors.

Advantageously, the first and second induction coils have different inductance values. The first induction coil may have a first inductance and the second induction coil may have a second inductance which is less than the first inductance. This means that the magnetic fields generated by the first and second induction coils will have different strengths for a given current. This may facilitate a different heating effect by the first and second induction coils while applying the same amplitude of current to both coils. This may reduce the control requirements of the aerosol-generating device. Where the first and second induction coils are activated independently, the induction coil with the greater inductance may be activated at a different time to the induction coil with the lower inductance. For example, the induction coil with the greater inductance may be activated during operation, such as during puffing, and the induction coil with the lower inductance may be activated between operations, such as between puffs. Advantageously, this may facilitate the maintenance of an elevated temperature within the cavity between uses without requiring the same power as normal use. This ‘pre-heat’ may reduce the time taken for the cavity to return to the desired operating temperature once operation of the aerosol-generating device use is resumed. Alternatively, the first induction coil and the second induction coil may have the same inductance values.

The first and second induction coils may be formed from the same type of wire. Advantageously, the first induction coil is formed from a first type of wire and the second induction coil is formed from a second type of wire which is different to the first type of wire. For example, the wire compositions or cross-sections may differ. In this manner, the inductance of the first and second induction coils may be different even if the overall coil geometries are the same. This may allow the same or similar coil geometries to be used for the first and second induction coils. This may facilitate a more compact arrangement.

The first type of wire may comprise a first wire material and the second type of wire may comprise a second wire material which is different from the first wire material. The electrical properties of the first and second wire materials may differ. For example, first type of wire may have a first resistivity and the second type of wire may have a second resistivity which is different to the first resistivity.

Suitable materials for the induction coil(s) include copper, aluminium, silver and steel. Preferably, the induction coil is formed from copper or aluminium.

Where the first induction coil is formed from a first type of wire and the second induction coil is formed from a second type of wire which is different to the first type of wire, the first type of wire may have a different cross-section to the second type of wire. The first type of wire may have a first cross-section and the second type of wire may have a second cross-section which is different to the first cross-section. For example, the first type of wire may have a first cross-sectional shape and the second type of wire may have a second cross-sectional shape which is different to the first cross-sectional shape. The first type of wire may have a first thickness and the second type of wire may have a second thickness which is different to the first thickness. The cross-sectional shape and the thickness of the first and second types of wire may be different.

The susceptor arrangement may be formed from any material that can be inductively heated to a temperature sufficient to aerosolise an aerosol-forming substrate. Suitable materials for the susceptor arrangement include graphite, molybdenum, silicon carbide, stainless steels, niobium, aluminium, nickel, nickel containing compounds, titanium, and composites of metallic materials. Preferred susceptor arrangements comprise a metal or carbon. Advantageously the susceptor arrangement may comprise or consists of a ferromagnetic material, for example, ferritic iron, a ferromagnetic alloy, such as ferromagnetic steel or stainless steel, ferromagnetic particles, and ferrite. A suitable susceptor arrangement may be, or comprise, aluminium. The susceptor arrangement may comprise more than 5 percent, preferably more than 20 percent, more preferably more than 50 percent or more than 90 percent of ferromagnetic or paramagnetic materials. Preferred susceptor arrangements may be heated to a temperature in excess of 250 degrees Celsius.

The susceptor arrangement may be formed from a single material layer. The single material layer may be a steel layer.

The susceptor arrangement may comprise a non-metallic core with a metal layer disposed on the non-metallic core. For example, the susceptor arrangement may comprise metallic tracks formed on an outer surface of a ceramic core or substrate.

The susceptor arrangement may be formed from a layer of austenitic steel. One or more layers of stainless steel may be arranged on the layer of austenitic steel. For example, the susceptor arrangement may be formed from a layer of austenitic steel having a layer of stainless steel on each of its upper and lower surfaces. The susceptor arrangement may comprise a single susceptor material. The susceptor arrangement may comprise a first susceptor material and a second susceptor material. The first susceptor material may be disposed in intimate physical contact with the second susceptor material. The first and second susceptor materials may be in intimate contact to form a unitary susceptor. In certain embodiments, the first susceptor material is stainless steel and the second susceptor material is nickel. The susceptor arrangement may have a two layer construction. The susceptor arrangements may be formed from a stainless steel layer and a nickel layer.

Intimate contact between the first susceptor material and the second susceptor material may be made by any suitable means. For example, the second susceptor material may be plated, deposited, coated, clad or welded onto the first susceptor material. Preferred methods include electroplating, galvanic plating and cladding.

The second susceptor material may have a Curie temperature that is lower than 500 degrees Celsius. The first susceptor material may be primarily used to heat the susceptor when the susceptor is placed in an alternating electromagnetic field. Any suitable material may be used. For example, the first susceptor material may be aluminium, or may be a ferrous material such as a stainless steel. The second susceptor material is preferably used primarily to indicate when the susceptor has reached a specific temperature, that temperature being the Curie temperature of the second susceptor material. The Curie temperature of the second susceptor material can be used to regulate the temperature of the entire susceptor during operation. Thus, the Curie temperature of the second susceptor material should be below the ignition point of the aerosol-forming substrate. Suitable materials for the second susceptor material may include nickel and certain nickel alloys. The Curie temperature of the second susceptor material may preferably be selected to be lower than 400 degrees Celsius, preferably lower than 380 degrees Celsius, or lower than 360 degrees Celsius. It is preferable that the second susceptor material is a magnetic material selected to have a Curie temperature that is substantially the same as a desired maximum heating temperature. That is, it is preferable that the Curie temperature of the second susceptor material is approximately the same as the temperature that the susceptor should be heated to in order to generate an aerosol from the aerosol-forming substrate. The Curie temperature of the second susceptor material may, for example, be within the range of 200 degrees Celsius to 400 degrees Celsius, or between 250 degrees Celsius and 360 degrees Celsius. In some embodiments it may be preferred that the first susceptor material and the second susceptor material are co-laminated. The co-lamination may be formed by any suitable means. For example, a strip of the first susceptor material may be welded or diffusion bonded to a strip of the second susceptor material. Alternatively, a layer of the second susceptor material may be deposited or plated onto a strip of the first susceptor material.

Preferably, the aerosol-generating device is portable. The aerosol-generating device may have a size comparable to a conventional cigar or cigarette. The system may be an electrically operated smoking system. The system may be a handheld aerosol-generating system. The aerosol-generating device may have a total length between approximately 30 millimetres and approximately 150 millimetres. The aerosol-generating device may have an external diameter between approximately 5 millimetres and approximately 30 millimetres.

The housing may be elongate. The housing may comprise any suitable material or combination of materials. Examples of suitable materials include metals, alloys, plastics or composite materials containing one or more of those materials, or thermoplastics that are suitable for food or pharmaceutical applications, for example polypropylene, polyetheretherketone (PEEK) and polyethylene. Preferably, the material is light and non-brittle.

The housing may comprise a mouthpiece. The mouthpiece may comprise at least one air inlet and at least one air outlet. The mouthpiece may comprise more than one air inlet. One or more of the air inlets may reduce the temperature of the aerosol before it is delivered to a user and may reduce the concentration of the aerosol before it is delivered to a user.

Alternatively, the mouthpiece may be provided as part of an aerosol-generating article.

As used herein, the term “mouthpiece” refers to a portion of an aerosol-generating device that is placed into a user's mouth in order to directly inhale an aerosol generated by the aerosol-generating device from an aerosol-generating article received in the cavity of the housing.

The air inlet may be configured as a semi-open inlet. The semi-open inlet preferably allows air to enter the aerosol-generating device. Air or liquid may be prevented from leaving the aerosol-generating device through the semi-open inlet. The semi-open inlet may for example be a semi-permeable membrane, permeable in one direction only for air, but is air- and liquid-tight in the opposite direction. The semi-open inlet may for example also be a one-way valve. Preferably, the semi-open inlets allow air to pass through the inlet only if specific conditions are met, for example a minimum depression in the aerosol-generating device or a volume of air passing through the valve or membrane.

Operation of the heating arrangement may be triggered by a puff detection system. Alternatively, the heating arrangement may be triggered by pressing an on-off button, held for the duration of the user's puff. The puff detection system may be provided as a sensor, which may be configured as an airflow sensor to measure the airflow rate. The airflow rate is a parameter characterizing the amount of air that is drawn through the airflow path of the aerosol-generating device per time by the user. The initiation of the puff may be detected by the airflow sensor when the airflow exceeds a predetermined threshold. Initiation may also be detected upon a user activating a button.

The sensor may also be configured as a pressure sensor to measure the pressure of the air inside the aerosol-generating device which is drawn through the airflow path of the device by the user during a puff. The sensor may be configured to measure a pressure difference or pressure drop between the pressure of ambient air outside of the aerosol-generating device and of the air which is drawn through the device by the user. The pressure of the air may be detected at the air inlet, the mouthpiece of the device, the cavity such as the heating chamber or any other passage or chamber within the aerosol-generating device, through which the air flows. When the user draws on the aerosol-generating device, a negative pressure or vacuum is generated inside the device, wherein the negative pressure may be detected by the pressure sensor. The term “negative pressure” is to be understood as a pressure which is relatively lower than the pressure of ambient air. In other words, when the user draws on the device, the air which is drawn through the device has a pressure which is lower than the pressure off ambient air outside of the device. The initiation of the puff may be detected by the pressure sensor if the pressure difference exceeds a predetermined threshold.

The aerosol-generating device may include a user interface to activate the aerosol-generating device, for example a button to initiate heating of the aerosol-generating device or display to indicate a state of the aerosol-generating device or of the aerosol-forming substrate.

An aerosol-generating system is a combination of an aerosol-generating device and one or more aerosol-generating articles for use with the aerosol-generating device. However, the aerosol-generating system may include additional components, such as, for example a charging unit for recharging an on-board electric power supply in an electrically operated or electric aerosol-generating device. The invention may also relate to an aerosol-generating system.

The aerosol-forming substrate may comprise nicotine. The nicotine-containing aerosol-forming substrate may be a nicotine salt matrix. The aerosol-forming substrate may comprise plant-based material. The aerosol-forming substrate may comprise tobacco. The aerosol-forming substrate may comprise a tobacco-containing material including volatile tobacco flavour compounds which are released from the aerosol-forming substrate upon heating. Alternatively, the aerosol-forming substrate may comprise a non-tobacco material. The aerosol-forming substrate may comprise homogenised plant-based material. The aerosol-forming substrate may comprise homogenised tobacco material. Homogenised tobacco material may be formed by agglomerating particulate tobacco. In a particularly preferred embodiment, the aerosol-forming substrate may comprise a gathered crimped sheet of homogenised tobacco material. As used herein, the term ‘crimped sheet’ denotes a sheet having a plurality of substantially parallel ridges or corrugations.

The aerosol-forming substrate may comprise at least one aerosol-former. An aerosol-former is any suitable known compound or mixture of compounds that, in use, facilitates formation of a dense and stable aerosol and that is substantially resistant to thermal degradation at the temperature of operation of the system. Suitable aerosol-formers are well known in the art and include, but are not limited to: polyhydric alcohols, such as triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. Preferred aerosol formers are polyhydric alcohols or mixtures thereof, such as triethylene glycol, 1,3-butanediol. Preferably, the aerosol former is glycerine. Where present, the homogenised tobacco material may have an aerosol-former content of equal to or greater than 5 percent by weight on a dry weight basis, and preferably from about 5 percent to about 30 percent by weight on a dry weight basis. The aerosol-forming substrate may comprise other additives and ingredients, such as flavourants.

In any of the above embodiments, the aerosol-generating article and the cavity of the aerosol-generating device may be arranged such that the aerosol-generating article is partially received within the cavity of the aerosol-generating device. The cavity of the aerosol-generating device and the aerosol-generating article may be arranged such that the aerosol-generating article is entirely received within the cavity of the aerosol-generating device.

The aerosol-generating article may be substantially cylindrical in shape. The aerosol-generating article may be substantially elongate. The aerosol-generating article may have a length and a circumference substantially perpendicular to the length. The aerosol-forming substrate may be provided as an aerosol-forming segment containing an aerosol-forming substrate. The aerosol-forming segment may be substantially cylindrical in shape. The aerosol-forming segment may be substantially elongate. The aerosol-forming segment may also have a length and a circumference substantially perpendicular to the length.

The aerosol-generating article may have a total length between approximately 30 millimetres and approximately 100 millimetres. In one embodiment, the aerosol-generating article has a total length of approximately 45 millimetres. The aerosol-generating article may have an external diameter between approximately 5 millimetres and approximately 12 millimetres. In one embodiment, the aerosol-generating article may have an external diameter of approximately 7.2 millimetres.

The aerosol-forming substrate may be provided as an aerosol-forming segment having a length of between about 7 millimetres and about 15 millimetres. In one embodiment, the aerosol-forming segment may have a length of approximately 10 millimetres. Alternatively, the aerosol-forming segment may have a length of approximately 12 millimetres.

The aerosol-generating segment preferably has an external diameter that is approximately equal to the external diameter of the aerosol-generating article. The external diameter of the aerosol-forming segment may be between approximately 5 millimetres and approximately 12 millimetres. In one embodiment, the aerosol-forming segment may have an external diameter of approximately 7.2 millimetres.

The aerosol-generating article may comprise a filter plug. The filter plug may be located at a downstream end of the aerosol-generating article. The filter plug may be a cellulose acetate filter plug. The filter plug may be a hollow cellulose acetate filter plug. The filter plug is approximately 7 millimetres in length in one embodiment, but may have a length of between approximately 5 millimetres to approximately 10 millimetres.

As used herein, the terms ‘upstream’ and ‘downstream’ are used to describe the relative positions of components, or portions of components, of the aerosol-generating device in relation to the direction in which a user draws on the aerosol-generating device during use thereof.

The aerosol-generating article may comprise an outer paper wrapper. Further, the aerosol-generating article may comprise a separation between the aerosol-forming substrate and the filter plug. The separation may be approximately 18 millimetres, but may be in the range of approximately 5 millimetres to approximately 25 millimetres.

Features described in relation to one embodiment may equally be applied to other embodiments of the invention.

The invention will be further described, by way of example only, with reference to the accompanying drawings in which:

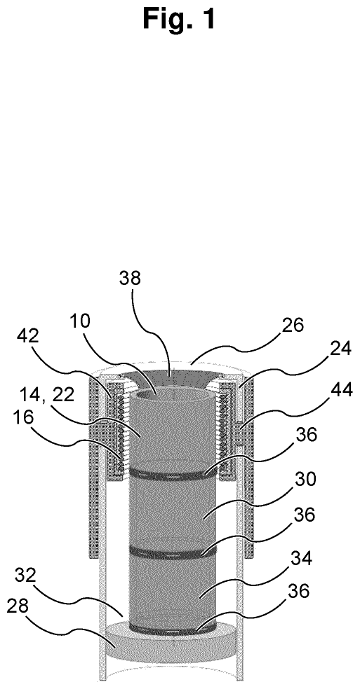

FIG. 1 shows an illustrative view of the aerosol-generating device of the present invention;

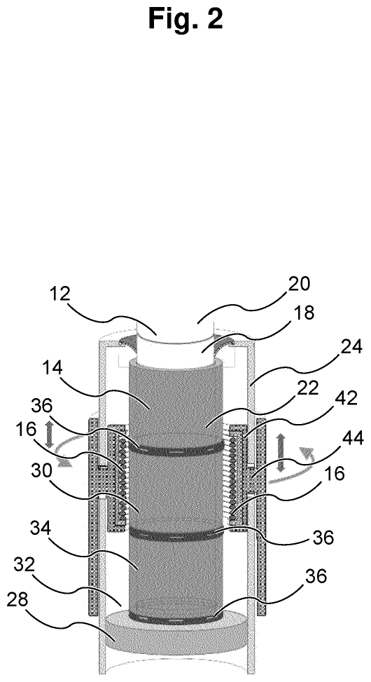

FIG. 2 shows an illustrative view of the aerosol-generating device of FIG. 1 with a moved induction coil;

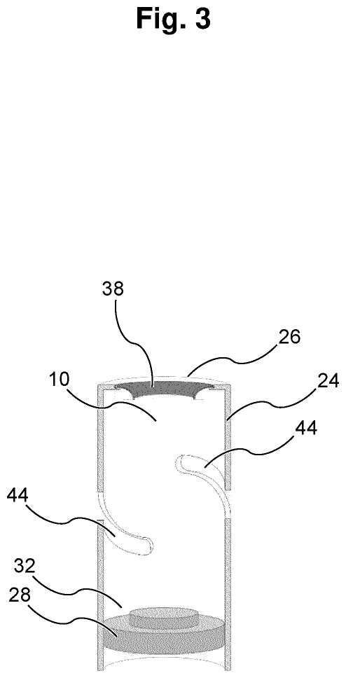

FIG. 3 shows the aerosol-generating device of FIGS. 1 and 2 with a guiding slot of a housing of the aerosol-generating device;

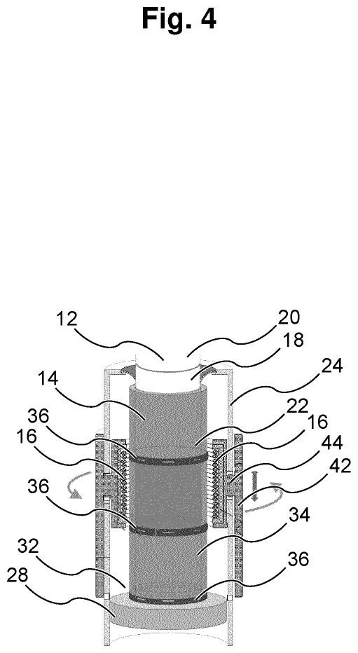

FIG. 4 shows the aerosol-generating device of any of FIGS. 1 to 3 during a heating operation;

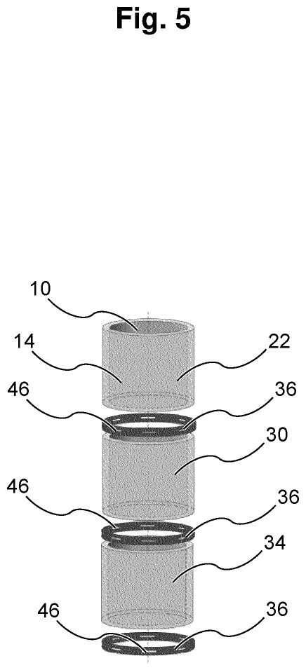

FIG. 5 shows the aerosol-generating device of any of FIGS. 1 to 4 with specifics regarding a susceptor arrangement;

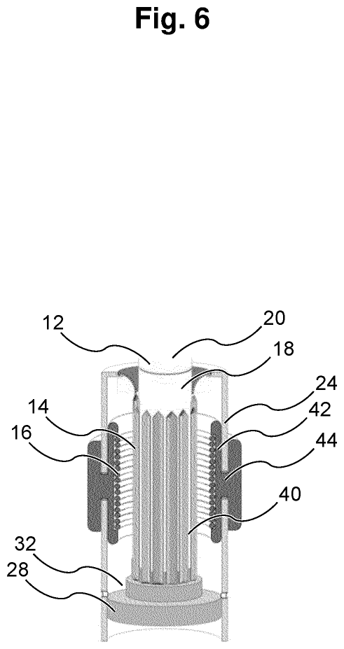

FIG. 6 shows a further embodiment of an aerosol-generating device with blade shape susceptors; and

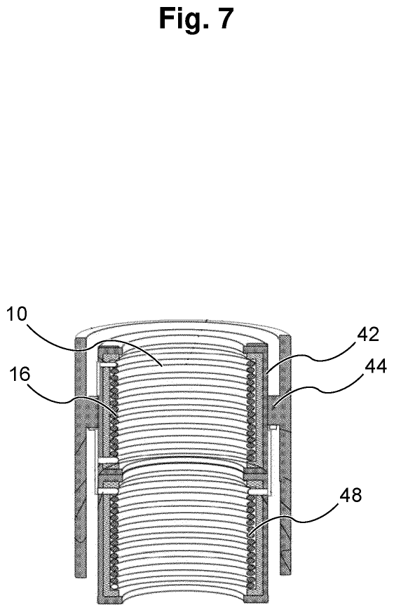

FIG. 7 shows an embodiment of the aerosol-generating device comprising two induction coils.

FIG. 1 shows a proximal or downstream portion of an aerosol-generating device. The aerosol-generating device comprises a cavity 10 for insertion of an aerosol-generating article 12. The aerosol-generating article 12 is depicted in FIGS. 2, 4 and 6. The cavity 10 is configured as a heating chamber.

Inside of the cavity 10, a susceptor arrangement 14 is arranged. The inner diameter of the susceptor arrangement 14 may correspond or may be slightly smaller than the outer diameter of the aerosol-generating article 12. The aerosol-generating article 12 may be held by the susceptor arrangement 14 after insertion of the aerosol-generating article 12 into the cavity 10. Alternatively, the inner diameter of the susceptor arrangement 14 may be larger than the outer diameter of the aerosol-generating article 12. The susceptor arrangement 14 may have a tubular shape.

The susceptor arrangement 14 is part of an induction heating arrangement. The induction heating arrangement comprises an induction coil 16. The induction coil 16 is arranged at least partly surrounding the cavity 10. Alternatively, the induction coil 16 may be arranged within the cavity 10. The induction coil 16 surrounds the full circumference of the cavity 10. The induction coil 16 is arranged surrounding the susceptor arrangement 14. The induction coil 16 surrounds the part of the cavity 10, in which a substrate portion 18 of the aerosol-generating article 12 is received. A filter portion 20 of the aerosol-generating article 12 sticks out of the cavity 10 after insertion of the aerosol-generating article 12 into the cavity 10. A user draws on the filter portion 20.

The induction coil 16 only surrounds a part of the cavity 10. This part of the cavity 10 surrounded by the induction coil 16 is referred to as a heating zone. As can be seen in FIG. 1, the induction coil 16 surrounds a downstream part of the cavity 10. The induction coil 16 surrounds a first susceptor 22. The first susceptor 22 is arranged surrounding the downstream part of the cavity 10. The first susceptor 22 is arranged surrounding a first heating zone corresponding to the space of the cavity 10 surrounded by the first susceptor 22.

The susceptor arrangement 14 comprises multiple susceptors in FIG. 1, in which three susceptors are depicted. Apart from the first susceptor 22, a second susceptor 30 and a third susceptor 34 are depicted. The induction coil 16 is configured movable between different heating positions. Each heating position of the induction coil 16 corresponds to a position surrounding a susceptor 22, 30, 34. Between each individual susceptor 22, 30, 34, an electrically insulating element 36 is arranged. The electrically insulating element 36 is ring shaped. The electrically insulating element 36 is tubular. At the upstream end of the susceptor arrangement 14, an electrically insulating element 36 is provided between the last susceptor 34 and a base 28 of the cavity 10. This upstream electrically insulating element 36 prevents electrical contact between the last susceptor 34 and the base 28 of the cavity 10. In the embodiment depicted in FIG. 1, three susceptors 22, 30, 34 are shown. However, this number is chosen for illustrative reasons. Depending upon the desired number of heating zones, a higher or lower number of susceptors may be provided. Preferably, the number of positions of the induction coil 16 corresponds to the number of susceptors being provided.

The aerosol-generating device comprises further elements not shown in the figures such as a controller for controlling the induction heating arrangement. The controller is configured to separately control individual coils, if the induction heating arrangement comprises more than one induction coil 16. The aerosol-generating device comprises a power supply such as a battery. The controller is configured to control the supply of electrical energy from the power supply to the induction coil 16 or to the individual induction coils 16.

In the base 28 of the cavity 10, an air aperture is provided. The air aperture has an elongate extension parallel to the longitudinal axis of the aerosol-generating device. The air aperture allows air to enter into the cavity 10 at an upstream end 32 of the cavity 10. A thermally insulating element is provided surrounding the sidewall of the cavity 10 or forming the sidewall of the cavity 10. The thermally insulating element prevents air from entering into the cavity 10 in a lateral direction.

An air inlet is provided to enable ambient air to enter the cavity 10. The air inlet is arranged at the downstream end of the housing 24. Alternatively, the air inlet is placed in the outer circumference of the housing 24 of the aerosol-generating device.

In FIG. 1, a resilient sealing element 38 is shown at the downstream end of the cavity 10. The resilient sealing element 38 is arranged surrounding the downstream end of the cavity 10. The resilient sealing element 38 has a circular shape. The resilient sealing element 38 has a funnel shape facilitating insertion of the aerosol-generating article 12. The resilient sealing element 38 applies pressure to the aerosol-generating article 12 after insertion of the aerosol-generating article 12 to hold the aerosol-generating article 12 in place. The resilient sealing element 38 is air impenetrable to prevent air from escaping the cavity 10 except for escaping through the aerosol-generating article 12.

To facilitate movement of the induction coil 16, a guiding element 42 is provided. The guiding element 42 is engaged with a guiding slot 44 of the housing 24 of the aerosol-generating device. The guiding element 42 partly surrounds the induction coil 16. The induction coil 16 is mounted on the guiding element 42. The guiding element 42 is movable within the guiding slot 44. Movement of the guiding element 42 within the guiding slot 44 results in a movement of the induction coil 16 from the position shown in FIG. 1 to the position shown in FIG. 2.

FIG. 2 shows an illustration of the aerosol-generating device, in which an aerosol-generating article 12 is inserted into the cavity 10. The substrate portion 18 of the aerosol-generating article 12 is received in the cavity 10. A filter portion 20 of the aerosol-generating article 12 may stick out of the cavity 10 for a user to draw on the aerosol-generating article 12.

In addition to the inserted aerosol-generating article 12, FIG. 2 shows that the induction coil 16 has been moved to a second heating position. In the second heating position, the induction coil 16 surrounds the second susceptor 30 of the susceptor arrangement 14. The movement from the first heating position to the second heating position is facilitated automatically by a motor. Particularly, the movement from the first heating position to the second heating position is facilitated if the aerosol-forming substrate of the aerosol-generating article 12 in the first heating zone corresponding to the first heating position of the induction coil 16 is depleted. After depletion of this aerosol-forming substrate, the induction coil 16 is automatically moved by the multiple to the second heating position. Alternatively to movement of the induction coil 16 automatically by a motor, the movement may be conducted by a user. Particularly, a rotate the outer part of the guiding element 42 so that the guiding element 42 slides within the guiding slot 44. The aerosol-generating device may comprise means for indicating to user that the aerosol-forming substrate in the first heating zone is depleted. Exemplarily, the aerosol-generating device may comprise optical means to indicate to a user that the induction coil 16 should be moved.

FIG. 3 shows the guiding slot 44 in more detail. Preferably, the guiding slot 44 has a helical shape. Consequently, a rotational movement of the guiding element 42 results in an axial movement of the induction coil 16.

FIG. 4 shows operation of the induction coil 16 in the second heating position for heating the aerosol-forming substrate of the aerosol-forming article 12 in the second heating zone.

FIG. 5 shows a detailed view of the susceptor arrangement 14. Particularly, the first susceptor 22, the second susceptor 30 and the third susceptor 34 are depicted in FIG. 5. FIG. 5 is an exploded view of the susceptor arrangement 14. Between the individual susceptors 22, 30, 34, the electrically insulating elements 36 may be arranged. The electrically insulating elements 36 are provided with slots 46 to enable airflow into the cavity 10 through the electrically insulating elements 36.

FIG. 6 shows an embodiment of a different configuration of the susceptor arrangement 14. In this embodiment, the susceptor arrangement 14 is configured as blade shaped susceptors. The blade shaped susceptors are elongate and extend parallel to the longitudinal axis of the cavity 10. In this embodiment, gaps 40 are provided between the blade shaped susceptors to enable radial airflow into the aerosol-generating article between the individual blade shaped susceptors. The inner diameter of the blade shaped susceptors corresponds to or is slightly smaller than the outer diameter of the aerosol-generating article 12 so that the susceptors hold the aerosol-generating article 12 in place after the aerosol-generating article 12 is received in the cavity 10.

More than one induction coil 16 may be provided. In addition to the induction coil 16, a second induction coil 48 is provided. Preferably, two induction coils 16, 48 or more than two induction coils are provided. The induction coils 16, 48 are part of the induction heating arrangement. The induction coils 16, 48 are separately controllable to enable heating of separate heating zones within the cavity 10. An embodiment of two induction coils 16, 48 is depicted in FIG. 7. Preferably, both induction coils 16, 48 are attached to the guiding element 42 so that both induction coils 16, 48 can be moved at the same time. The combination of providing multiple induction coils 16, 48 and configuring the induction coils 16, 48 movable enables a variety of potential heating regimes. Separately controlling the individual induction coils 16, 48 already enables separate heating of at least two heating zones. In addition, movement of the induction coils 16, 48 by means of movement of the guiding element 42 within the guiding slot 44 enables the induction coils 16, 48 to be moved to different heating zones. As desired, independent control of the individual induction coils 16, 48 as well as movement of the induction coils 16, 48 to different heating positions may be combined.

1.-11. (canceled)

12. An aerosol-generating device, comprising:
a cavity configured to receive an aerosol-generating article comprising an aerosol-forming substrate; and
an induction heating arrangement comprising
a susceptor arrangement and an induction coil, the induction coil being arranged at least partly surrounding the susceptor arrangement, and the induction coil being arranged axially movable along the susceptor arrangement, and
a guiding element configured to guide the axial movement of the induction coil,
wherein the induction coil is configured to be movable to at least a first heating position and a second heating position around the cavity,
wherein the susceptor arrangement comprises at least a first susceptor and a second susceptor, which are arranged distanced from each other along a longitudinal axis of the aerosol-generating device, and
wherein the induction coil is further configured to be movable to surround the first susceptor corresponding to the first heating position and to be movable to surround the second susceptor corresponding to the second heating position.

13. The aerosol-generating device according to claim 12,
further comprising a housing,
wherein the housing comprises a guiding slot, and
wherein the guiding element is configured to be engageable or to be engaged with the guiding slot.

14. The aerosol-generating device according to claim 13, wherein the guiding slot is configured as a helical guiding slot.

15. The aerosol-generating device according to claim 13, wherein the guiding element and the guiding slot are further configured to enable a rotational movement of the induction coil around the longitudinal axis of the aerosol-generating device thereby leading to the axial movement of the induction coil.

16. The aerosol-generating device according to claim 12,
wherein the susceptor arrangement is arranged along a full length of the cavity, and
wherein the induction coil partly surrounds the susceptor arrangement.

17. The aerosol-generating device according to claim 12,
further comprising a motor configured to move the induction coil,
wherein the aerosol-generating device is configured to automatically move the induction coil between the first heating position and the second heating position.

18. The aerosol-generating device according to claim 12, wherein an electrically insulating element is arranged between the first susceptor and the second susceptor.

19. The aerosol-generating device according to claim 12, wherein the induction coil is further configured to be movable with respect to a housing of the aerosol-generating device.

20. The aerosol-generating device according to claim 12, wherein the susceptor arrangement further comprises at least two elongate susceptors arranged to be parallel to the longitudinal axis of the aerosol-generating device.

21. The aerosol-generating device according to claim 12, wherein gaps are provided between the susceptors.

22. The aerosol-generating device according to claim 12, wherein the susceptors are arranged around a sidewall of the cavity in a tubular arrangement.
